(19) United States
(12) Patent Application Publication
(10) Pub. No.: US 2003/0197423 A1
(43) Pub. Date: Oct. 23, 2003

(54) Combining device provided between a wheel and an axle

(76) Inventor: Gordon Liao, Yung Kang City (TW)

Correspondence Address: Keith Kline, PRO-TECHTOR INTERNATIONAL SERVICES, 20775 Norada Court, Saratoga, CA, 95070-3018, US

(21) Appl. No.: 10/128,401

(22) Filed: Apr. 22, 2002

(51) Int. Cl. B60B 23/00

(52) U.S. Cl. 301/111.03

(57) ABSTRACT

A combining device provided between a wheel and an axle includes a main body fixed in the center hole of a wheel, a pull handle fitted in the main body, and a combining base secured at one end of the axle. The main body is formed with a hollow interior for the combining base to be inserted therein. The pull handle is fitted around with a spring for pressing down a shaft under the pull handle. The shaft is inserted in the interior of the main body and restricted to stay in a position-limiting section of the combining base positioned in the main body. The main body is provided on top with a deep and a shallow groove formed crossing each other for the pull handle to rest therein through pulling and shifting. Thus, the shaft under the pull handle is controlled to let the wheel engaged and disengaged from or detached from the axle.

### BACKGROUND OF THE INVENTION

This invention relates to a combining device provided between a wheel and an axle, particularly to one capable of making a wheel and an axle engage or disengage from each other with quickness, and possible to let the wheel rotate independently.

For the present, the wheel and the axle of an electrically driven car are fixedly combined together mostly by a bolt. Or a pin 1 shown in FIG. 1 is usually employed for combining an axle 2 with a wheel 3 together in order to separate them conveniently. However, these two combining ways respectively have defects described below.

1. If an axle and a wheel are fixedly combined together by a bolt, it is necessary to use a screwdriver to disengage the wheel from the axle later on, inconvenient in detaching and combining.

2. If an axle and a wheel 3 are fastened together by a pin 1, the vibration force produced by the wheel 3 running on a rough ground is liable to cause the pin 1 to fall off.

3. An electrically driven car has to be pushed to move by manpower once its power (such as the battery of a motor) is used up. In this case, since the axle and the wheel of a conventional electrically driven car are fixedly combined together, when the wheels are rotated, the wheel shaft together with the gear and the motor within a power system will synchronously be forced to rotate, thus requiring much labor for moving the electrically driven car.

### SUMMARY OF THE INVENTION

The objective of the invention is to offer a combining device provided between a wheel and an axle, possible to let the wheel and the axle detached and combined with quickness, requiring no screwdriver for help, and adjustable to let the wheel rotate independently if necessary, enabling an electrically driven car to be moved with a little manpower when its power is used up.

### GRIEF DESCRIPTION OF DRAWINGS

This invention will be better understood by referring to the accompanying drawings, wherein:

FIG. 1 is a perspective view of the wheel and the axle of a conventional electrically driven car:

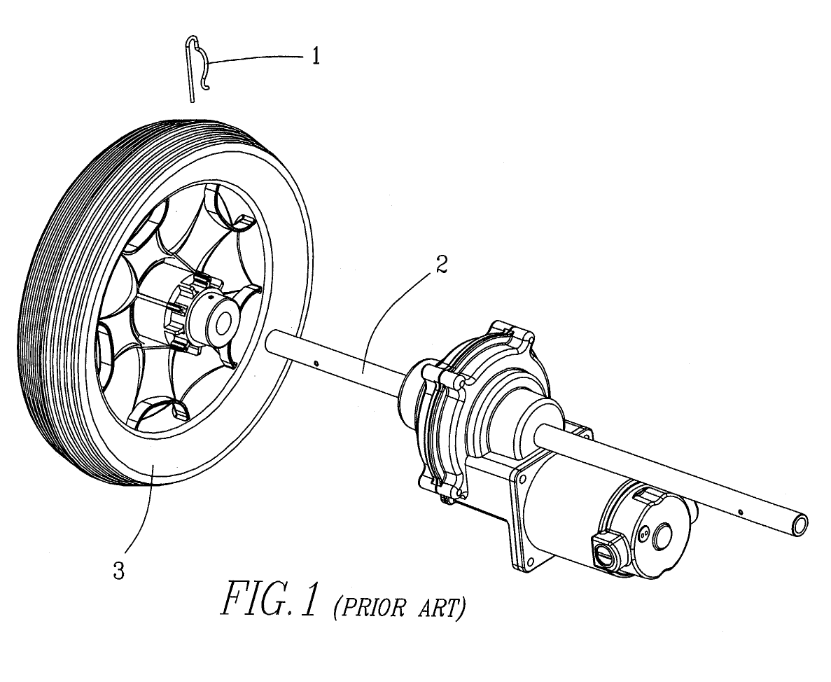

FIG. 2 is an exploded perspective view of a combining device provided between a wheel and an axle in the present invention:

FIG. 3 is a perspective view of the combining device provided between a wheel and an axle in the present invention:

FIG. 4 is a cross-sectional view of the combining device in a condition of a wheel combined with a wheel shaft in the present invention:

FIG. 5 is a cross-sectional view of the connecting-disconnecting device in a condition of the wheel disengaged from the axle in the present invention:

FIG. 6 is a perspective view of the combining device in a condition of the wheel separated from an axle in the present invention:

FIG. 7 is an exploded perspective view of the combining device applied to other kinds of cars:

FIG. 8 is a cross-sectional view of the components in FIG. 7 combined together: and,

FIG. 9 is a perspective view of the components in FIG. 7 combined together.

### DETAILED DESCRIPTION OF THE PREFERRED EMBODIMENT

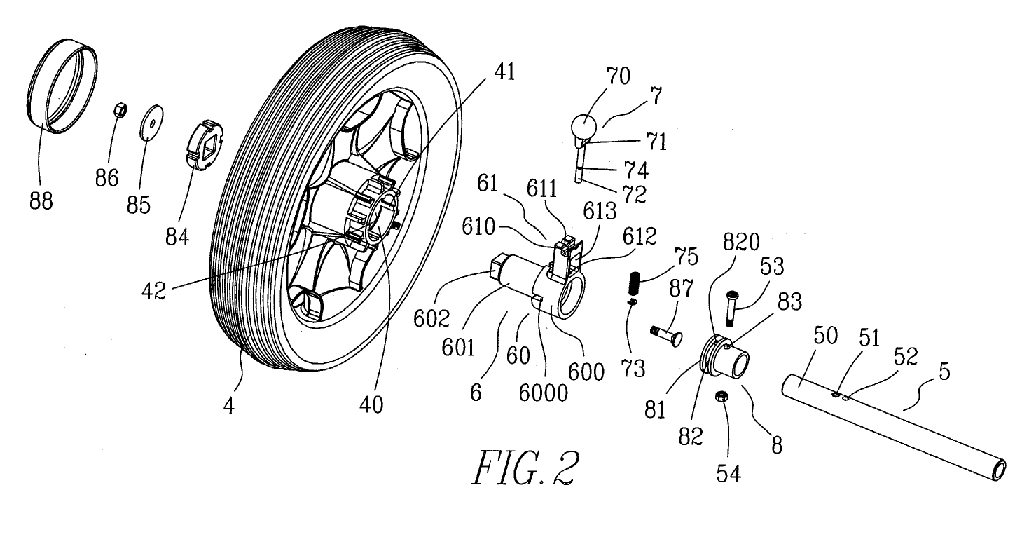

A preferred embodiment of a combining device provided between a wheel and an axle in the present invention, as shown in FIG. 2, includes a main body 6, a pull handle 7, and a combining base 8 as main components combined together.

The main body 6 is L-shaped, composed of a horizontal base 60 and a vertical base 61. The horizontal base 60 has a hollow annular base 600 positioned exactly under the vertical base 61, and the hollow annular base 600 is connected with a hollow shaft 601 extending rearward laterally, with the outer diameter of the hollow shaft 601 smaller than the inner diameter of the annular base 600. A hollow square projection 602 is fixed protruding out of the end of the hollow shaft 601. Besides, the annular base 600 has slots 6000 formed on its outer wall for correspondingly engaging with projecting ribs 41 formed on the central wheel frame of a wheel 4.

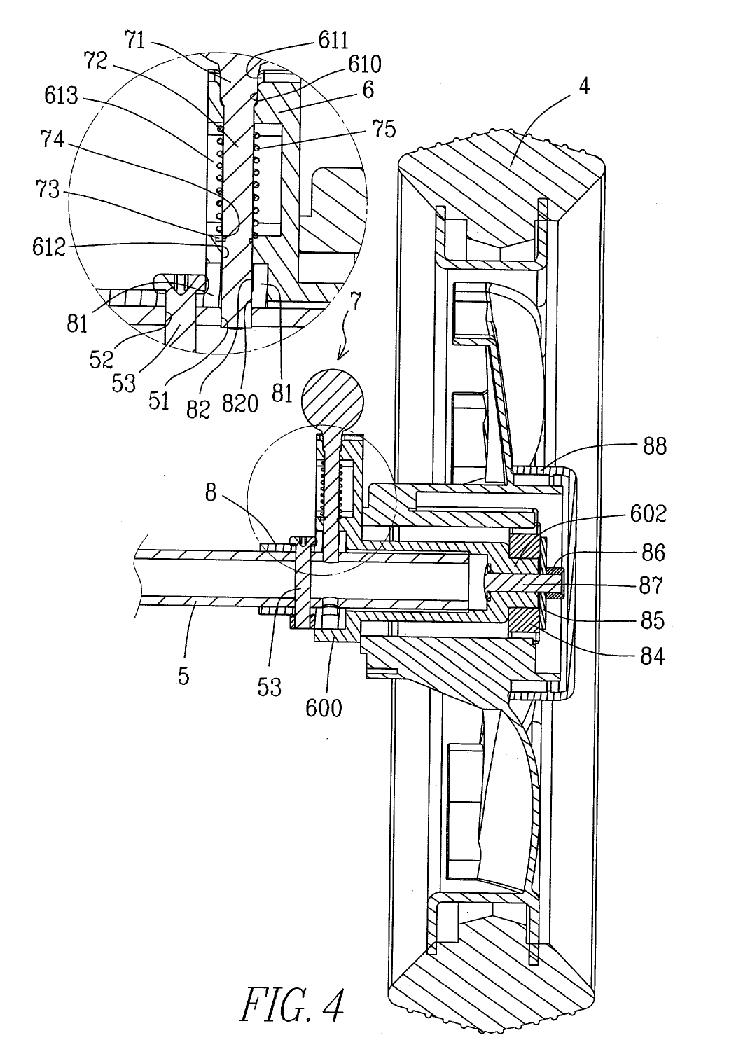

The vertical base 61 of the main body 6 is provided on top with a deep groove 610 and shallow groove 611 located crossing each other, and a through hole 612 bored at a crossing point of the deep and the shallow grooves 610, 611, communicating with the interior of the annular base 600, as shown in FIG. 4. Further, a square side opening 613 communicating crosswise with the through hole 612 is formed on the front sidewall of the vertical base 61.

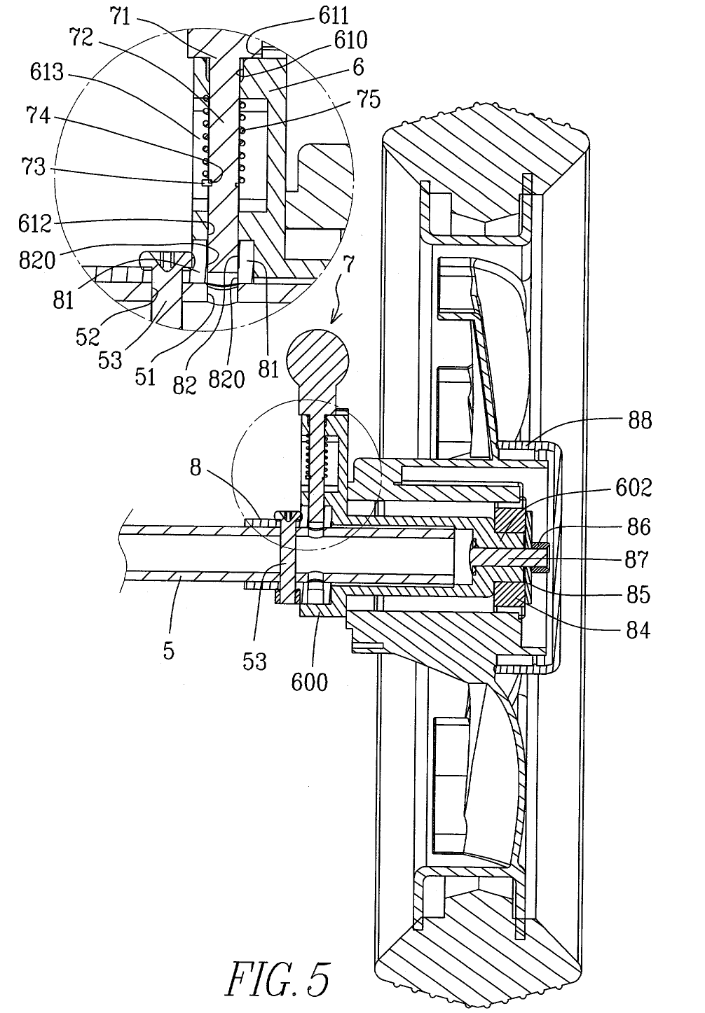

The pull handle 7 is formed with a pulling knob 70 on top for facilitating moving the pull handle 7. A support base 71 is provided under the pulling knob 70 to rest in the deep and the shallow groove 610, 611 of the vertical base 61, as shown in FIGS. 4 and 5. The support base 71 is secured with a shaft 72 extending downward to be inserted into the through hole 612 in the center of the deep and the shallow grooves 610, 611, and the shaft 72 is formed with an annular groove 74 in a lower portion for a C-shaped clasp 73 to be locked therein, as shown in FIG. 4.

A spring 75 is fitted in the square side opening 613 of the main body 6 and aligned to the through hole 612 inside the square side opening 613 so as to permit the shaft 72 of the pull handle 7 to be inserted through the through hole 612 and the spring 75, and then the shaft 72 has its annular groove 74 locked by a C-shaped clasp 73, as shown in FIG. 4. Thus, the spring 75 can be restricted in the square side opening 613 of the main body 6, with its top end pushing elastically against the upper wall of the square side opening 613 and its bottom end resisting the C-shaped clasp 73 to elastically pull down the pull handle 7 permanently.

The combining base 8 is shaped as a hollow shaft and provided with two parallel projecting rings 81 around the front end, with a position-limiting section 82 formed between the two projecting rings 81. The position-limiting section 82 has its inner side and outer side respectively bored with a position-limiting hole 820 and a positioning hole 83.

In assembling, the pull handle 7 and the spring 75 are first fitted in the square side opening 613 of the main body 6 as described above. Then, the projection 602 of the horizontal base 60 of the main body 6 is inserted in the center hole 42 of the wheel 4, and the slots 6000 of the annular base 600 are respectively made to engage with the projecting ribs 41 on the central wheel frame 40, so that the wheel 4 and the main body 6 can rotate together. And after inserted through the center hole 42 of the wheel 4, the projection 602 of the main body 6 has its end extending out of the rear end of the center hole 42 orderly fitted with a locking block 84, a washer 85 and a nut 86 and then fastened together by means of a bolt 87 passing through the interior of the projection 802 and extending out to be tightly screwed with the nut 86, thus enabling the main body 6 stably positioned on the wheel 4, as shown in FIG. 4. Further, a hubcap 88 is provided near a combining end of the bolt 87 and the nut 86, covered on the wheel 4, as shown in FIG. 4.

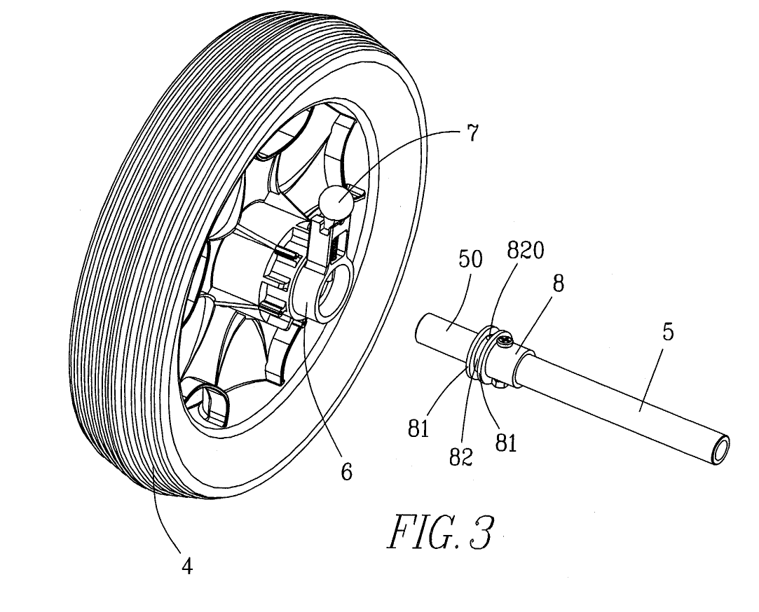

Next, the combining base 8 is assembled together with the wheel shaft 5. The axle 5 is inserted into the center hole of the combining base 8, having its front axle portion 50 of a proper length extending out of the center hole to be inserted in the hollow shaft 601 of the main body 6. The axle 5 is provided with two through holes 51, 52 matching with the position-limiting hole 820 and the positioning hole 83 of the combining base 8, as shown in FIG. 2. Then, a bolt 53 is threaded through the positioning hole 83 of the combining base 8 and the through hole 52 of the wheel shaft 5, and tightly screwed with a nut 54 to finish combining the combining base 8 with the axle 5, as shown in FIG. 3.

Lastly, the front axle portion 50 of the axle 5 is fitted in the hollow shaft 601 of the main body 6. In case the support base 71 of the pull handle 7 rests in the deep groove 610 of the main body 6, as shown in FIG. 4, just slightly pulling up the pull handle 7 to a position can allow the front axle portion 50 extend into the hollow shaft 601 of the main body 6. At this time, only rotate the wheel 4 to let the shaft 72 under the pull handle 7 automatically get into the position-limiting hole 820 of the combining base 8 and the through hole 51 of the wheel shaft 5 by means of the spring 75 elastically pushing down the shaft 72 (because of the spring 75 pressing downward against the C-shaped clasp 73 on the spindle 72), unnecessary to make the shaft 72 aligned to the position-limiting hole 820 and the through hole 51, thus obtaining an effect of quick and convenient combination.

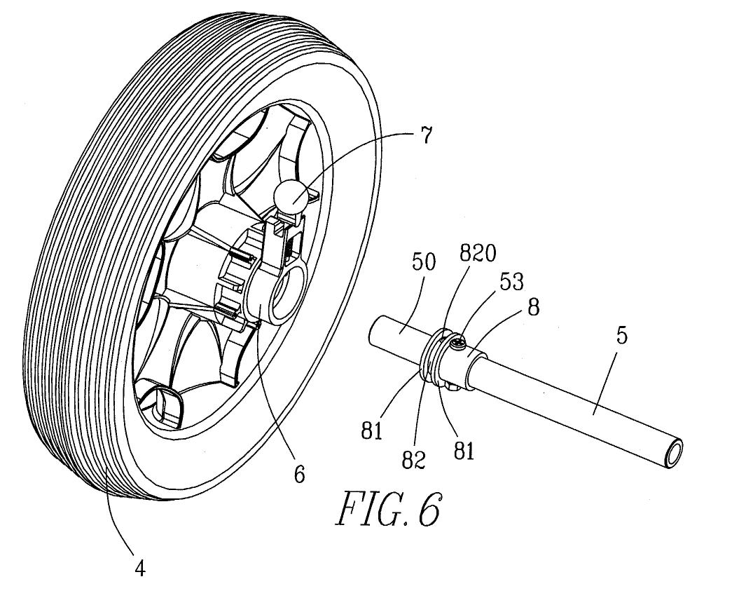

On the contrary, to separate the wheel 4 from the axle 5, simply pull up the pull handle 7 to let the shaft 72 not reach in the position-limiting hole 820 of the combining base 8, and the wheel 4 can easily be disengaged from the wheel shaft 5, as shown in FIG. 6.

As an important feature of the invention in using, to rotate the wheel 4 independently from the wheel shaft 5, the pull handle 7 is slightly pulled up to let the support base 71 get out of the deep groove 610, and then the pull handle 7 is turned for 90 degrees and released to let its support base 71 automatically get into the shallow groove 611 due to the downward resilience of the spring 75, as shown in FIG. 5. The different height between the deep and the shallow grooves 610, 611 is just high enough to enable the shaft 72 under the pull handle 7 to move up and get away from the through hole 51 of the axle 5, but at this time the shaft 72 is blocked by the two projecting rings 81 and kept within the position-limiting section 82 of the combining base 8 so that the wheel 4 still engages with the shaft 5. Thus, when the wheel 4 is rotated, the wheel shaft 5 will not be actuated to rotate together, saving manpower in moving a car.

On the contrary, to make the wheel 4 and the axle 5 rotate together, only slightly pull up the pull handle 7 and turn it for 90 degrees to allow the support base 71 rest in the deep groove 610, as shown in FIG. 4. At this time, so long as the wheel 4 is rotating, the shaft 72 will automatically get into the through hole 51 of the axle 5 because of the downward resilience of the spring 75, whether or not the shaft 72 is aligned to the through hole 51, achieving an effect of quickly engaging the wheel 4 with the axle 5 to rotate together.

As can be noted from the above description, the combining device provided between a wheel and an axle in the present invention is much more convenient and labor-saving than a conventional one in detaching a wheel from an axle or in combining and separating them, needless to employ a screwdriver for help.

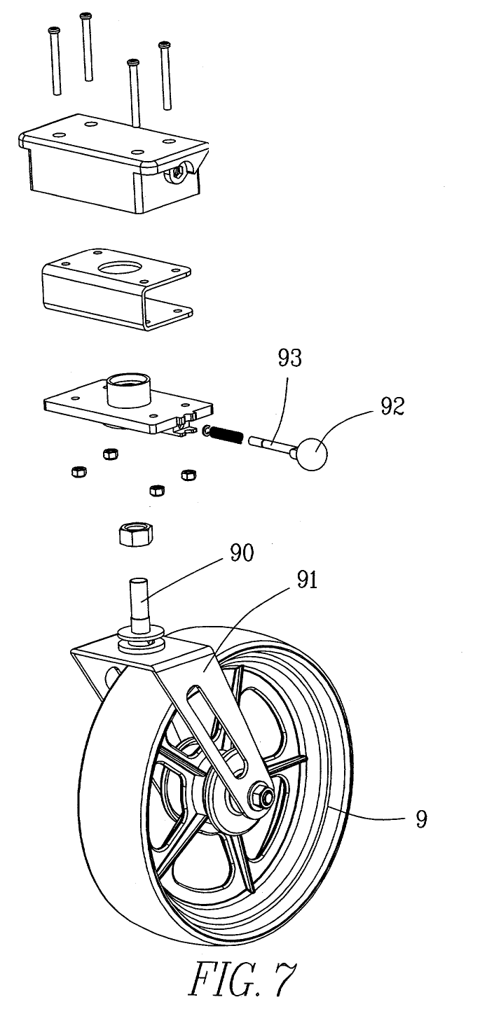

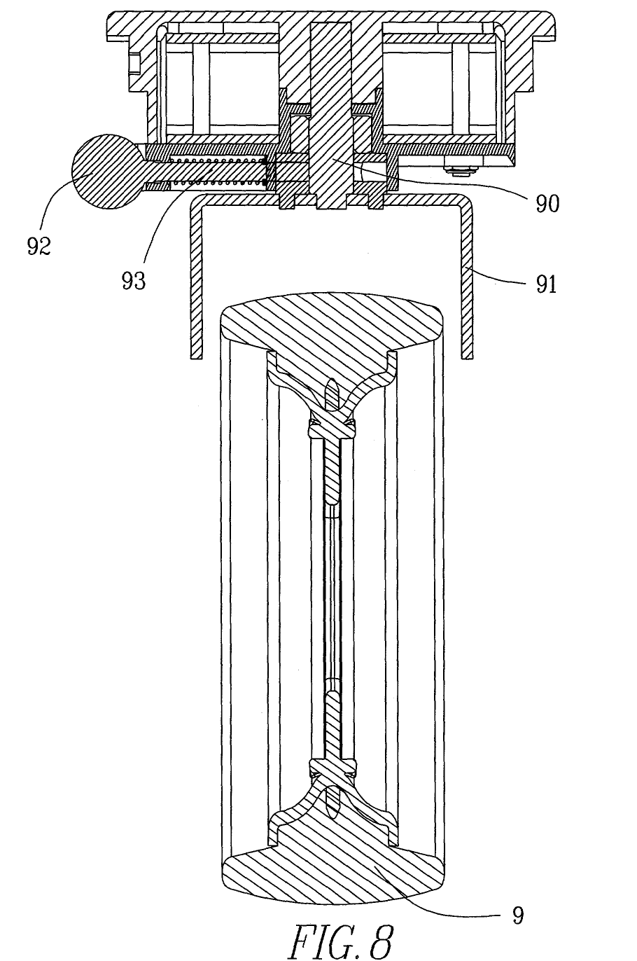

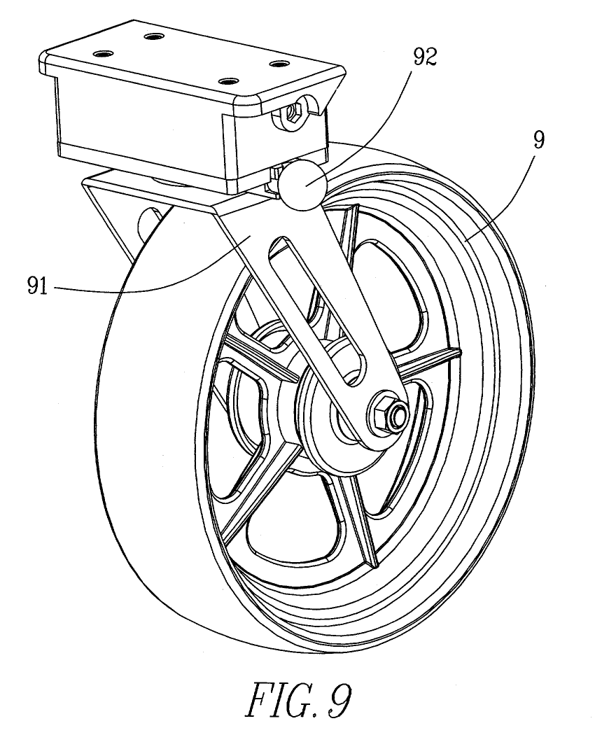

In addition, the design of this invention can also be applied to other devices necessary to be disengaged. As shown in FIGS. 7, 8 and 9, a wheel 9 can be combined with a wheel frame 91 able to rotate freely around a center shaft 90 in such a way that the wheel 9 can change directions for 360 degrees. Such a structure is commonly provided on a barrow for the convenience of changing directions. However, if such a conventional barrow needs to be altered to have a single function of running straight, the wheel frame 91 has to be replaced by one, which can restrict the barrow to go straight only.

The device of this invention can be applied to solve the above-mentioned problem. In case the spindle 93 of a pull handle 92 is locked in position with the center shaft 90 on the wheel frame 91, the wheel 9 can keep going forward straight. Besides, the device of this invention can quickly separate the wheel from the axle of a barrow, convenient in storing.

While the preferred embodiment of the invention has been described above, it will be recognized and understood that various modifications may be made therein and the appended claims are intended to cover all such modifications that may fall within the spirit and scope of the invention.

I claim:

1. A combining device provided between a wheel and an axle comprising:
A main body composed of a horizontal base and a vertical base, said horizontal base fitted in a center hole of a wheel and formed with a hollow interior for receiving a combining base, said vertical base positioned on said horizontal base and bored on top with a deep groove and a shallow grooves, said deep and said shallow grooves positioned crossing each other, a through hole provided at a crossing point of said deep and said shallow groove, said through hole facing downward and communicating with the interior of said horizontal base, said horizontal base further having a slots formed on the outer wall for receiving projecting ribs formed on a central wheel frame of a wheel, said vertical base having a square side opening formed on a front side wall, said square side opening communicating crosswise with said through hole:
A pull handle provided with a support base to rest in said deep or said shallow groove of said main body, said support base fixed with a shaft extending downward and having an annular groove at a lower portion, a spring fitted in said square side opening of said main body, said pull handle inserted downward into said through hole of said main body and extending through said spring to have its annular groove locked by a C-shaped clasp, said shaft of said pull handle pressed down constantly by the downward elastic force of said spring:
A combining base shaped as a hollow shaft, said combining base provided with two projecting rings at its front end and having a position-limiting section formed between said two projecting rings, a position-limiting hole and a positioning hole respectively provided inside and outside said position-limiting section, an axle extending through said combining base and inserted into the interior of said horizontal base of said main body, said axle bored with two through holes corresponding to said position-limiting hole and said positioning hole of said combining base, said position-limiting hole and the corresponding through hole of said axle fastened in place by a bolt: and,
Said pull handle pulled upward to let said spindle not rest in said horizontal base, said combining base around the front end of said axle inserted into said horizontal base, said shaft automatically getting into said through hole of said axle due to a downward resilience of said spring when said wheel is rotated, needless to make said spindle aligned to both said position-limiting hole of said detaching base and said through hole of said axle; said support base of said pull handle resting in said deep groove of said main body to enable said wheel and said axle engaged to rotate together; said pull handle pulled upward slightly and turned for 90 degrees to allow said support base to rest in said shallow groove in case said wheel is to be disengaged from said axle, the different height between said deep and said shallow grooves being just high enough to enable said shaft to move up and get out of said through hole of said axle, thus said axle no longer actuated to rotate when said wheel rotates, said shaft blocked by said projecting rings and restricted within said position-limiting section of said combining base to permit said wheel still engaged with said axle, said pull handle pulled up high enough to permit said shaft get out of said position-limiting section if said wheel is to be disengaged from said axle, said wheel possible to be conveniently disengaged from said axle without need of a screwdriver for help, said wheel capable of being rotated independently when the power of an electrically driven car is used up.
